(19) United States
(12) Patent Application Publication
(10) Pub. No.: US 2018/0129149 A1
(43) Pub. Date: May 10, 2018

(54) Stirring/conveying member, and developing device and image forming apparatus therewith

(71) Applicant: KYOCERA Document Solutions Inc., Osaka (JP)

(72) Inventor: Akifumi YAMAGUCHI, Osaka (JP)

(73) Assignee: KYOCERA Document Solutions Inc., Osaka (JP)

(21) Appl. No.: 15/713,085

(22) Filed: Sep. 22, 2017

(30) Foreign Application Priority Data
Nov. 9, 2016 (JP) 2016-219067

(51) Int. Cl. G03G 15/08

(52) U.S. Cl. CPC G03G 15/0889; G03G 15/0812

(57) ABSTRACT

A stirring/conveying member has a rotary shaft rotatably supported in a powder container, a first helical blade formed on the circumferential surface of the rotary shaft and conveying powder in the axial direction by the rotation of the rotary shaft, and a second helical blade formed on the circumferential surface of the rotary shaft to overlap the forming region of the first helical blade, spiraling in the opposite phase to the first helical blade, and having a smaller radial height than the first helical blade. The first helical blade crosses the second helical blade at least at one place in one turn about the rotary shaft. At least one of the radial heights of the first and second helical blades equals zero at the intersection of the first and second helical blades.

### INCORPORATION BY REFERENCE

This application is based upon and claims the benefit of priority from the corresponding Japanese Patent Application No. 2016-219067 filed on Nov. 9, 2016, the entire contents of which are incorporated herein by reference.

### BACKGROUND

The present disclosure relates to a stirring/conveying member that conveys, while stirring, powder such as developer, to a developing device provided with such a stirring/conveying member, and to an image forming apparatus incorporating such a developing device.

In image forming apparatuses, a latent image formed on an image carrying member comprising a photosensitive member or the like is made visible by being developed into a toner image by a developing device. Some such developing devices adopt a two-component developing system that uses two-component developer. In this type of developing device, developer containing carrier and toner is stored in a developer container, there is arranged a developing roller which feeds the developer to the image carrying member, and there is arranged a stirring/conveying member which conveys, while stirring, the developer inside the developer container to feed it to the developing roller.

In the two-component developing system, insufficient electrostatic charging of toner may lead to image defects such as splashed toner and a foggy image. Thus, it is necessary to sufficiently stir and mix toner and carrier together to electrostatically charge the toner to a predetermined charging amount.

As a solution, a powder stirring/conveying member is known which includes a shaft member, a main conveying blade which conveys powder in a first direction toward one side of the axial direction as the shaft member rotates, and a sub-conveying means which exerts on part of the powder a conveying action in a second direction toward the other side of the axial direction as the shaft member rotates. As the sub-conveying means, a sub-conveying blade is known which has a smaller diameter than the main conveying blade and which spirals in the opposite direction (opposite phase) to the main conveying blade.

A stirring/conveying member is known which includes a rotary shaft, a first helical blade which is formed on the circumferential surface of the rotary shaft and which conveys powder in the axial direction by the rotation of the rotary shaft, and a second helical blade which is formed on the circumferential surface of the rotary shaft to overlap the forming region of the first helical blade, spirals in the opposite phase to the first helical blade, and has a smaller radial diameter than the first helical blade. In this stirring/conveying member, the first helical blade and the second helical blade have a trapezoidal sectional shape on a plane traversing the helical blades in their longitudinal direction. In the first helical blade and the second helical blade, there are respectively formed a plurality of first expansion portions and second expansion portions where the base part of the trapezoid expands wider than elsewhere in one turn about the rotary shaft. The first and second helical blades cross each other at least at one place at the first expansion portion in one turn about the rotary shaft.

With the above configurations, the second helical blade (sub-conveying blade) exerts a conveying force in the direction opposite to the developer conveyance direction of the first helical blade (main conveying blade), and thus convection occurs on part of the conveyed developer; this promotes the stirring effect with almost no interference with the conveying action of the first helical blade (main conveying blade). As a result, the stirring/conveying member can, while retaining both the conveying force of powder such as developer and the stirring effect, avoid applying excessive stress to the powder and is excellent in moldability.

### SUMMARY

According to one aspect of the present disclosure, a stirring/conveying member includes a rotary shaft, a first helical blade, and a second helical blade. The rotary shaft is rotatably supported in a powder container. The first helical blade is formed on the circumferential surface of the rotary shaft, and conveys powder in the axial direction by the rotation of the rotary shaft. The second helical blade is formed on the circumferential surface of the rotary shaft to overlap the forming region of the first helical blade, spirals in the opposite phase to the first helical blade, and has a radial height smaller than that of the first helical blade. The first helical blade and the second helical blade have a trapezoidal sectional shape on a plane traversing the helical blades in their longitudinal direction. The first helical blade crosses the second helical blade at least at one place in one turn about the rotary shaft. At least one of the radial heights of the first helical blade and the second helical blade equals zero at the intersection of the first helical blade and the second helical blade.

Further features and advantages of the present disclosure will become apparent from the description of embodiments given below.

### BRIEF DESCRIPTION OF THE DRAWINGS

FIG. 1 is a schematic diagram showing an overall construction of an image forming apparatus incorporating a developing device according to the present disclosure;

FIG. 2 is a side sectional view of the developing device incorporating first and second spirals constituting a stirring/conveying member according to the present disclosure;

FIG. 3 is a sectional plan view of a stirring portion in the developing device according to the present disclosure;

FIG. 4 is a partly enlarged view of a second spiral according to a first embodiment of the present disclosure as seen from the direction perpendicular to a rotary shaft;

FIG. 5 is a partly enlarged view of a modified example of the second spiral according to the first embodiment where first and second expansion portions are respectively formed in first and second helical blades as seen from the direction perpendicular to a rotary shaft;

FIG. 6 is a partly enlarged view of a second spiral according to a second embodiment of the present disclosure as seen from the direction perpendicular to a rotary shaft;

FIG. 7 is a partly enlarged view of a second spiral according to a third embodiment of the present disclosure as seen from the direction perpendicular to a rotary shaft;

FIG. 8 is a partly enlarged view of a second spiral according to a fourth embodiment of the present disclosure as seen from the direction perpendicular to a rotary shaft;

FIG. 9 is a partly enlarged view of a second spiral according to a fifth embodiment of the present disclosure as seen from the direction perpendicular to a rotary shaft; and

FIG. 10 is a partly enlarged view of a second spiral according to a sixth embodiment of the present disclosure as seen from the direction perpendicular to a rotary shaft.

### DETAILED DESCRIPTION

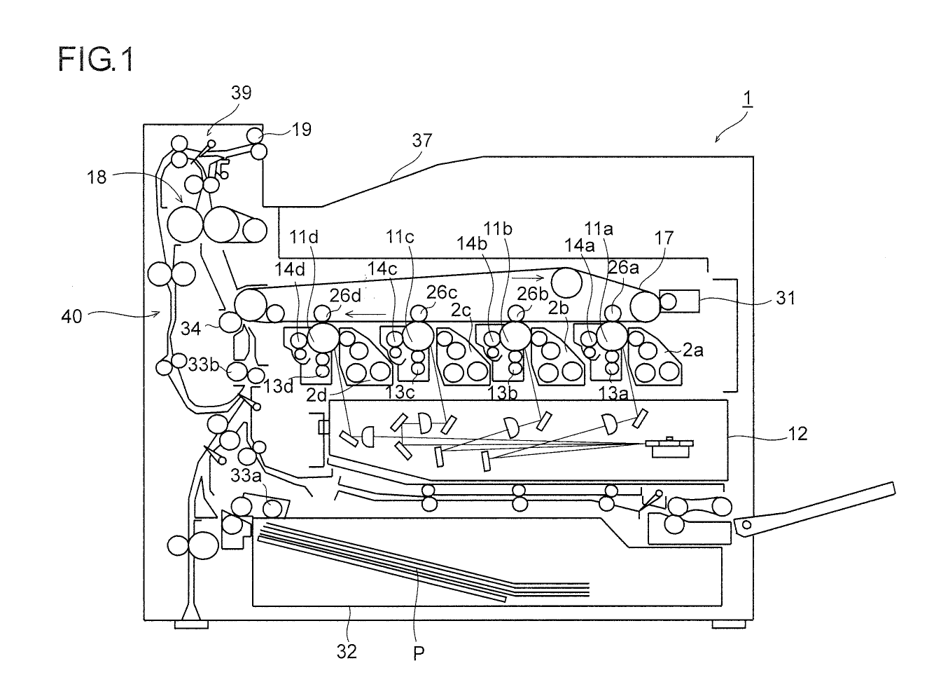

Hereinafter, embodiments of the present disclosure will be described with reference to the accompanying drawings. FIG. 1 is a schematic sectional view of an image forming apparatus 1 incorporating developing devices 2a to 2d according to the present disclosure, here showing a tandem-type color printer. In the image forming apparatus 1, there are respectively arranged photosensitive drums 11a, 11b, 11c, and 11d that carry visible images (toner images) of different colors, and these sequentially form cyan, magenta, yellow, and black images respectively, each through the processes of electrostatic charging, exposure to light, image development, and image transfer. Moreover, an intermediate transfer belt 17 that rotates in the clockwise direction in FIG. 1 is arranged next to the photosensitive drums 11a to 11d.

When image data is fed in from a host device such as a personal computer, first, by charging devices 13a to 13d, the surfaces of the photosensitive drums 11a to 11d are electrostatically charged uniformly. Then, through irradiation by an exposing device 12 with light based on the image data, electrostatic latent images based on the image data are formed on the photosensitive drums 11a to 11d respectively. The developing devices 2a to 2d are charged with predetermined amounts of two-component developer (hereinafter, also referred to simply as developer) containing toner of different colors, namely cyan, magenta, yellow, and black respectively, from toner containers (unillustrated). The toner contained in the developer is fed from the developing devices 2a to 2d to the photosensitive drums 11a to 11d, and electrostatically attaches to them. Thereby, toner images are formed based on the electrostatic latent images formed by exposure to light from the exposing device 12.

Then, an electric field is applied, by primary transfer rollers 26a to 26d, between the primary transfer rollers 26a to 26d and the photosensitive drums 11a to 11d with a predetermined transfer voltage. Thereby, the cyan, magenta, yellow, and black toner images on the photosensitive drums 11a to 11d are primarily transferred to the intermediate transfer belt 17. Toner and the like that remain on the surfaces of the photosensitive drums 11a to 11d after primary transfer are removed by cleaning devices 14a to 14d.

Transfer sheets P to which toner images are to be transferred are stored in a sheet cassette 32 arranged in a lower part inside the image forming apparatus 1. A transfer sheet P is conveyed, via a sheet feeding roller 33a and a registration roller pair 33b, with predetermined timing, to a nip (secondary transfer nip) between a secondary transfer roller 34, which is arranged next to the intermediate transfer belt 17, and the intermediate transfer belt 17. The transfer sheet P having the toner images secondarily transferred to it is conveyed to a fixing portion 18. Toner and the like that remain on the surface of the intermediate transfer belt 17 after secondary transfer are removed by a belt cleaning device 31.

The transfer sheet P conveyed to the fixing portion 18 is then heated and pressed there so that the toner images are fixed to the surface of the transfer sheet P to form a predetermined full-color image. The transfer sheet P having the full-color image formed on it is discharged as it is (or after being distributed by a branching portion 39 into a reverse conveyance passage 40 and having images formed on both sides of it) onto a discharge tray 37 via a discharge roller pair 19.

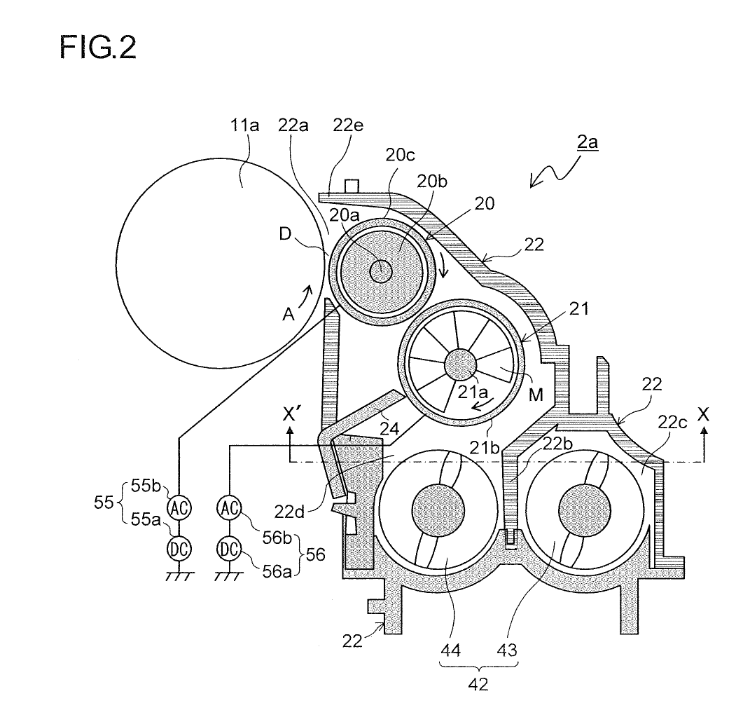

FIG. 2 is a side sectional view showing the structure of the developing device 2a according to the present disclosure. Although the following description deals with the structure and operation of the developing device 2a corresponding to the photosensitive drum 11a shown in FIG. 1, the structure and operation of the developing devices 2b to 2d are similar to those of the developing device 2a, and thus no overlapping description will be repeated.

As shown in FIG. 2, the developing device 2a includes a developing roller 20, a magnetic roller 21, a regulating blade 24, a stirring/conveying member 42, a developer container 22, and the like.

The developer container 22 forms the housing of the developing device 2a, and is divided, in a lower part of it, into a first conveyance chamber 22c and a second conveyance chamber 22d by a partition 22b. In the first conveyance chamber 22c and the second conveyance chamber 22d, developer containing carrier and toner is stored. The developer container 22 rotatably holds the stirring/conveying member 42, the magnetic roller 21, and the developing roller 20. In the developer container 22, there is formed an opening 22a through which the developing roller 20 is exposed toward the photosensitive drum 11a.

The developing roller 20 is arranged opposite the photosensitive drum 11a across a predetermined distance, on the right side of the photosensitive drum 11a. The developing roller 20 forms, at a position opposite and close to the photosensitive drum 11a, a developing region D where toner is fed to the photosensitive drum 11a. The magnetic roller 21 is arranged opposite the developing roller 20 across a predetermined distance, obliquely on the lower right side of the developing roller 20. The magnetic roller 21 feeds, at a position opposite and close to the developing roller 20, toner to the developing roller 20. The stirring/conveying member 42 is arranged substantially under the magnetic roller 21. The regulating blade 24 is fixedly held on the developer container 22, obliquely on the lower left side of the magnetic roller 21.

The stirring/conveying member 42 is composed of two spirals, namely a first spiral 43 and a second spiral 44. The second spiral 44 is arranged under the magnetic roller 21, in the second conveyance chamber 22d. The first spiral 43 is arranged next to the second spiral 44, on the right side of it, in the first conveyance chamber 22c.

The first and second spirals 43 and 44, while stirring developer, electrostatically charge the toner contained in the developer up to a predetermined level. This allows the toner to be held on the carrier. Communication portions (unillustrated) are provided in opposite longitudinal-direction (the front/rear direction with respect to the plane of FIG. 2) end parts of the partition 22b which separates the first conveyance chamber 22c and the second conveyance chamber 22d. As the first spiral 43 rotates, the charged developer is conveyed to the second spiral 44 via one of the communication portions provided in the partition 22b, so that the developer circulates through the first conveyance chamber 22c and the second conveyance chamber 22d. Then, the developer is fed from the second spiral 44 to the magnetic roller 21.

The magnetic roller 21 is composed of a roller shaft 21a, a magnetic pole member M, and a non-magnetic sleeve 21b formed of a non-magnetic material. The magnetic roller 21 carries on it the developer fed from the stirring/conveying member 42, and feeds, out of the developer, the toner alone to the developing roller 20. The magnetic pole member M has a plurality of magnets, which are each formed to have a fan-shaped section and which have on their peripheral parts different magnetic polarities from one to the next, arranged alternately. The magnetic pole member M is fixed to the roller shaft 21a with adhesive or otherwise. The roller shaft 21a is non-rotatably supported on the developer container 22 in the non-magnetic sleeve 21b, with a predetermined distance between the magnetic pole member M and the non-magnetic sleeve 21b. The non-magnetic sleeve 21b rotates in the same direction (the clockwise direction in FIG. 2) as the developing roller 20 by the action of a driving mechanism comprising a motor and gears, of which none is illustrated. To the non-magnetic sleeve 21b, a bias 56 having an AC voltage 56b superimposed on a DC voltage 56a is applied. On the surface of the non-magnetic sleeve 21b, the charged developer is carried in the form of a magnetic brush by the magnetic force of the magnetic pole member M, and the magnetic brush is adjusted to have a predetermined height by the regulating blade 24.

As the non-magnetic sleeve 21b rotates, the magnetic brush is conveyed while being carried on the surface of the non-magnetic sleeve 21b by the magnetic pole member M. When the magnetic brush makes contact with the developing roller 20, the toner alone out of the magnetic brush is fed to the developing roller 20 according to the bias 56 applied to the non-magnetic sleeve 21b.

The developing roller 20 is composed of a fixed shaft 20a, a magnetic pole member 20b, a developing sleeve 20c formed of a non-magnetic metal material in a cylindrical shape, and the like.

The fixed shaft 20a is non-rotatably supported on the developer container 22. Around the fixed shaft 20a, the developing sleeve 20c is rotatably held, and to the fixed shaft 20a, the magnetic pole member 20b comprising a magnet is fixed with adhesive or otherwise at a position opposite the magnetic roller 21, at a predetermined distance from the developing sleeve 20c. The developing sleeve 20c rotates in the direction indicated by an arrow in FIG. 2 (the clockwise direction) by the action of a driving mechanism comprising a motor and gears, of which none is illustrated. To the developing sleeve 20c, a developing bias 55 having an AC voltage 55b superimposed on a DC voltage 55a is applied.

As the developing sleeve 20c to which the developing bias 55 is applied rotates in the clockwise direction in FIG. 2, in the developing region D, due to the potential difference between the developing bias and the bias of the exposed part of the photosensitive drum 11a, toner carried on the surface of the developing sleeve 20c flies to the photosensitive drum 11a. The flying toner attaches, sequentially, to the exposed part on the photosensitive drum 11a that rotates in the direction indicated by arrow A (the counter-clockwise direction), and thereby the electrostatic latent image on the photosensitive drum 11a is developed.

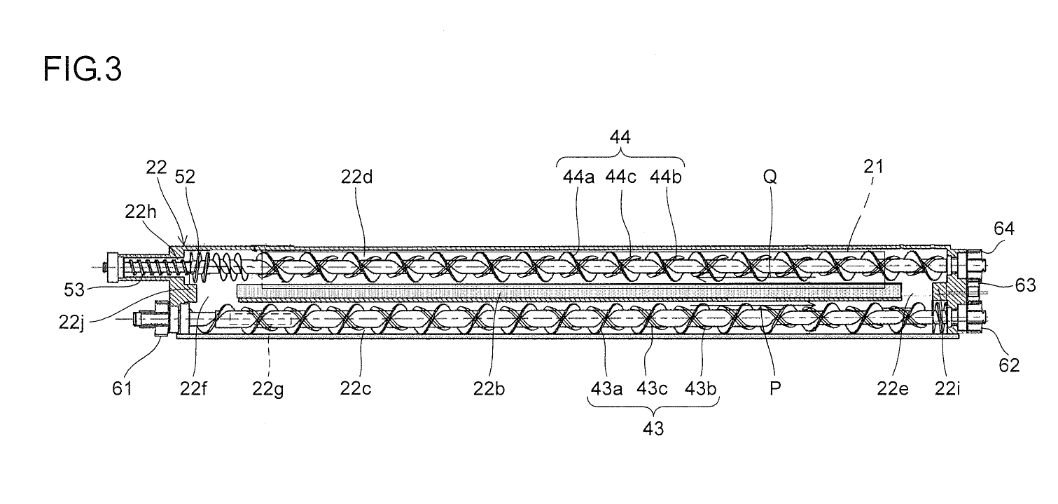

Now, a stirring portion in the developing device 2a will be described in detail with reference to FIG. 3. FIG. 3 is a sectional plan view (sectional view across line X-X′in FIG. 2 as seen from the direction indicated by arrows X and X′) of the stirring portion of the developing device 2a.

In the developer container 22 are formed, as described above, the first conveyance chamber 22c, the second conveyance chamber 22d, the partition 22b, the upstream-side communication portion 22e, and the downstream-side communication portion 22f. In the developer container 22, there are further formed a developer supply port 22g, a developer discharge port 22h, an upstream-side wall portion 22i, and a downstream-side wall portion 22j. With respect to the first conveyance chamber 22c, the left side in FIG. 3 is the upstream side, and the right side in FIG. 3 is the downstream side; with respect to the second conveyance chamber 22d, the right side in FIG. 3 is the upstream side, and the left side in FIG. 3 is the downstream side. Thus, the communication portions and the wall portions are distinguished between the upstream-side and downstream-side ones relative to the second conveyance chamber 22d.

The partition 22b extends in the longitudinal direction of the developer container 22 to separate the first conveyance chamber 22c and the second conveyance chamber 22d parallel to each other. On one hand, the right-side end part of the partition 22b in the longitudinal direction forms the upstream-side communication portion 22e together with the inner wall part of the upstream-side wall portion 22i. On the other hand, the left-side end part of the partition 22b in the longitudinal direction forms the downstream-side communication portion 22f together with the inner wall part of the downstream-side wall portion 22j. Developer passes, sequentially, through the first conveyance chamber 22c, the upstream-side communication portion 22e, the second conveyance chamber 22d, and the downstream-side communication portion 22f to circulate through the developer container 22.

The developer supply port 22g is an opening through which fresh toner and carrier are supplied from a developer supply container (unillustrated) provided over the developer container 22 into the developer container 22, and is arranged on the upstream side (the left side in FIG. 3) of the first conveyance chamber 22c.

The developer discharge port 22h is an opening through which developer that becomes surplus in the first and second conveyance chambers 22c and 22d as fresh developer is supplied is discharged, and is provided continuous with the second conveyance chamber 22d in the longitudinal direction on the downstream side of the second conveyance chamber 22d.

The first spiral 43 has a rotary shaft 43b, a first helical blade 43a formed in a helical shape with a predetermined pitch in the axial direction of the rotary shaft 43b, a second helical blade 43c spiraling in the opposite direction (opposite phase) to the first helical blade 43a with the same pitch as the first helical blade 43a in the axial direction of the rotary shaft 43b. The first helical blade 43a and the second helical blade 43c are provided to extend up to opposite end parts of the first conveyance chamber 22c in the longitudinal direction and to face the upstream-side and downstream-side communication portions 22e and 22f. The rotary shaft 43b is rotatably supported on the upstream-side wall portion 22i and the downstream-side wall portion 22j of the developer container 22. The first helical blade 43a and the second helical blade 43c are molded integrally with the rotary shaft 43b out of synthetic resin.

The second spiral 44 has a rotary shaft 44b, a first helical blade 44a in the axial direction of the rotary shaft 44b, and a second helical blade 44c spiraling in the opposite direction (opposite phase) to the first helical blade 44a with the same pitch as the first helical blade 44a in the axial direction of the rotary shaft 44b. The first helical blade 44a spirals in the opposite direction (opposite phase) to the first helical blade 43a with the same pitch as the first helical blade 43a of the first spiral 43. The first helical blade 44a and the second helical blade 44c have a length equal to or larger than that of the magnetic roller 21 in the axial direction, and are provided so as to extend up to a position facing the upstream-side communication portion 22e. The rotary shaft 44b is arranged parallel to the rotary shaft 43b, and is rotatably supported on the upstream-side wall portion 22i and the downstream-side wall portion 22j of the developer container 22. On the rotary shaft 44b, a regulating portion 52 and a discharge blade 53 are integrally arranged together with the first helical blade 44a and the second helical blade 44c. The structures of the first helical blades 43a and 44a and the second helical blades 43c and 44c will be described in detail later.

The regulating portion 52 makes it possible to block the developer conveyed to the downstream side in the second conveyance chamber 22d and to convey developer in excess of a predetermined amount to the developer discharge port 22h. The regulating portion 52 comprises a helical blade spiraling in the opposite direction (opposite phase) to the first helical blade 44a provided on the rotary shaft 44b, and is configured to have substantially the same outer diameter as, but a smaller pitch than, the first helical blade 44a. The regulating portion 52 forms a predetermined gap between an inner wall part of the developer container 22, such as the downstream-side wall portion 22j, and an outer circumferential part of the regulating portion 52. The surplus developer is discharged through the gap.

The rotary shaft 44b extends into the developer discharge port 22h. On the rotary shaft 44b in the developer discharge port 22h, the discharge blade 53 is provided. The discharge blade 53 comprises a helical blade spiraling in the same direction as the first helical blade 44a, but has a smaller pitch and a smaller blade circumference than those of the first helical blade 44a. Thus, as the rotary shaft 44b rotates, the discharge blade 53 also rotates so that the surplus developer conveyed into the developer discharge port 22h over the regulating portion 52 is conveyed to the left side in FIG. 3 to be discharged out from the developer container 22. The discharge blade 53, the regulating portion 52, the first helical blade 44a, and the second helical blade 44c are molded integrally with the rotary shaft 44b out of synthetic resin.

On the outer wall of the developer container 22, gears 61 to 64 are arranged. The gears 61 and 62 are fixed on the rotary shaft 43a, the gear 64 is fixed on the rotary shaft 44b, and the gear 63 is rotatably held on the developer container 22 to mesh with the gears 62 and 64.

According to the first spiral 43 structured as described above, the first helical blade 43a is provided on the outer surface of the rotary shaft 43b, and as the rotary shaft 43b rotates, the first helical blade 43a, while stirring, conveys developer in a first direction (the direction indicated by arrow P in FIG. 3). On the outer surface of the rotary shaft 43b, in a pitch (between one turn and the next) of the first helical blade 43a, the second helical blade 43c is provided which spirals in the opposite phase to the first helical blade 43a and which has a smaller diameter than that of the first helical blade 43a. As the rotary shaft 43b rotates, the second helical blade 43c exerts on developer a conveying action in a second direction (the direction indicated by arrow Q) which is the direction opposite to the first direction.

According to the second spiral 44 structured as described above, the first helical blade 44a is provided on the outer surface of the rotary shaft 44b, and as the rotary shaft 44b rotates, the first helical blade 44a, while stirring, conveys developer in the first direction (the direction indicated by arrow Q in FIG. 3). On the outer surface of the rotary shaft 44b, in a pitch (between one turn and the next) of the first helical blade 44a, the second helical blade 44c is provided which spirals in the opposite phase to the first helical blade 44a and which has a smaller diameter than that of the first helical blade 44a. As the rotary shaft 44b rotates, the second helical blade 44c exerts on developer, a conveying action in the second direction (the direction indicated by arrow P) which is the direction opposite to the first direction.

With the second helical blades 43c and 44c arranged radially inward of the outer end parts of the first helical blades 43a and 44a, the conveying action in the second direction produced by the rotation of the second helical blades 43c and 44c acts on a part of the developer present near the rotary shafts 43b and 44b. It thus does not hinder the conveying action in the first direction produced by the first helical blades 43a and 44a.

By producing, by use of the second helical blades 43c and 44c, a conveying action in the opposite direction (the second direction) to the developer conveyance direction (the first direction) of the first helical blades 43a and 44a as described above, convection of developer occurs in the pitch of the first helical blades 43a and 44a; this promotes stirring of developer in the pitch of the first helical blades 43a and 44a without hindering the powder (developer) conveying action by the first helical blades 43a and 44a. Thus, it is possible to speedily and sufficiently stir fresh toner and carrier, which are supplied via the developer supply port 22g, with two-component developer in the first conveyance chamber 22c and the second conveyance chamber 22d, and also to effectively prevent the conveyance speed of developer in the first conveyance chamber 22c and the second conveyance chamber 22d from reducing.

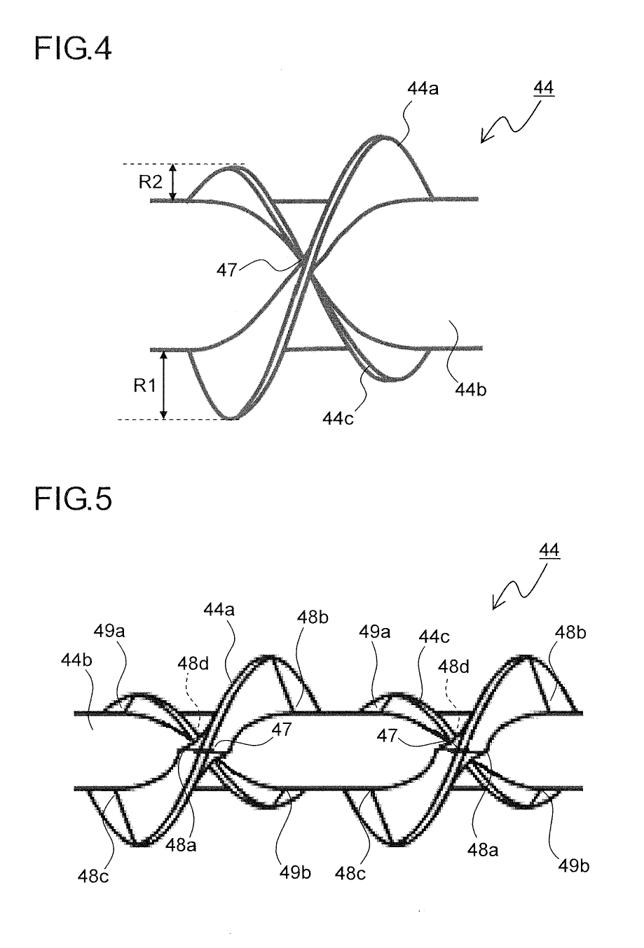

When the height (radial height R2; see FIG. 4) from the rotary shafts 43b and 44b to the tip ends of the second helical blades 43c and 44c is smaller than a quarter of the height (radial height R1; see FIG. 4) from the rotary shafts 43b and 44b to the tip ends of the first helical blades 43a and 44a, it is impossible to produce sufficient convection of developer in the pitch of the first helical blades 43a and 44a, and this reduces the effect of stirring. On the other hand, when R2 is larger than a half of R1, the conveying force in the second direction of the second helical blades 43c and 44c is too strong, and it thus inconveniently hinders the conveying action in the first direction produced by the first helical blades 43a and 44a.

Thus, the radial height R2 of the second helical blades 43c and 44c preferably is equal to or larger than a quarter of the radial height R1 of the first helical blades 43a and 44a but equal to or smaller than a half of it. This helps effectively prevent the conveying speed from reducing while producing convection of developer in the pitch of the first helical blades 43a and 44a.

Now, with reference to FIGS. 4 to 10, the structures of the first helical blade 44a and the second helical blade 44c of the second spiral 44 arranged in the second conveyance chamber 22d will be described in detail. The first helical blade 43a and the second helical blade 43c of the first spiral 43 arranged in the first conveyance chamber 22c have similar structures, and thus no overlapping description will be repeated.

FIG. 4 is a partly enlarged view of the second spiral 44 according to a first embodiment of the present disclosure as seen from the direction perpendicular to the rotary shaft 44b. As shown in FIG. 4, the first helical blade 44a and the second helical blade 44c constituting the second spiral 44 have a trapezoidal sectional shape on a plane traversing the helical blades in their longitudinal direction. The first helical blade 44a and the second helical blade 44c are formed to intersect at two intersections 47, at an interval of 180° from each other, in one turn of the first helical blade 44a and the second helical blade 44c about the rotary shaft 44b. The radial height R2 of the second helical blade 44c is smaller than the radial height R1 of the first helical blade 44a.

In this embodiment, the radial height R2 of the second helical blade 44c is the smaller the closer to the intersection 47 such that, at the intersection 47, R2=0. With this configuration, on the downstream side of the first helical blade 44a in the advance direction of its phase, the developer that stagnates in a region between the first helical blade 44a and the second helical blade 44c is more likely to disperse over the second helical blade 44c. On the other hand, on the upstream side of the first helical blade 44a in the advance direction of its phase, the developer is more likely to enter, over the second helical blade 44c, a region between the first helical blade 44a and the second helical blade 44c where the density of developer is low.

Thus, it is possible to suppress stagnation of developer and lowering of developer density near the intersection 47, and thereby to prevent developer from being uneven locally near the intersection 47; it is thus possible to effectively overcome image unevenness resulting from non-uniform developer being fed to the developing roller 20. The first helical blade 44a is formed continuously without being interrupted at the intersection 47, and thus there is no danger of a reduced conveying force of the first helical blade 44a.

FIG. 5 is a partly enlarged view of a modified example of the second spiral 44 according to the first embodiment as seen from the direction perpendicular to the rotary shaft 44b. In the modified example shown in FIG. 5, in the first helical blade 44a, in one turn (pitch) about the rotary shaft 44b, portions (hereinafter, referred to as first expansion portions) 48a to 48d where the base part of the trapezoid expands wider than elsewhere are formed at four places at an interval of 90° from each other. Likewise, in the second helical blade 44c, in one turn (pitch) about the rotary shaft 44b, portions (hereinafter, referred to as second expansion portions) 49a and 49b where the base part of the trapezoid expands wider than elsewhere are formed at two places at an interval of 180° from each other. The first helical blade 44a crosses the second helical blade 44c at two places, specifically at two of the first expansion portions 48a and 48d at an interval of 180° from each other in one turn about the rotary shaft 44b.

By forming the first expansion portions 48a to 48d and the second expansion portions 49a and 49b, it is possible to increase the effect of reinforcing the first helical blade 44a and the second helical blade 44c, and thus to improve the performance of stirring/conveying developer. As compared with the configuration in which the base parts of the entire first helical blade 44a and second helical blade 44c are expanded, it is possible to reduce the volume of the first helical blade 44a and the second helical blade 44c, and to increase the space (for holding toner) in the pitch of the first helical blade 44a and the second helical blade 44c. When the second spiral 44 is formed by molding, expanding the parts corresponding to the seams in the mold makes it easy to separate the second spiral 44 from the mold.

The intersection 47 of the first helical blade 44a and the second helical blade 44c is arranged at the same position as the first expansion portions 48a and 48d of the first helical blade 44a, and thus it is possible to integrate together the first expansion portions 48a and 48d and the intersection 47 between the first helical blade 43a and the second helical blade 43c, of which both influence the flow of developer, and thereby to reduce the influence on developer. As a result, it is possible to suppress ruffling of developer and to suppress stress applied to developer, and thus it is possible to effectively overcome insufficient electrostatic charging of toner resulting from deterioration of carrier.

As shown in FIG. 5, the first expansion portion 48b of the first helical blade 44a where the first helical blade 44a does not cross the second helical blade 44c and the second expansion portion 49a of the second helical blade 44c where the second helical blade 44c does not cross the first helical blade 44a are located substantially on the same straight line in the axial direction of the rotary shaft 44b. The first expansion portion 48c arranged at a position where the phase is deviated 180° from the first expansion portion 48b and the second expansion portion 49b arranged at a position where the phase is deviated 180° from the second expansion portion 49a are located substantially on the same straight line in the axial direction of the rotary shaft 44b. Thus, as compared with a case where the first expansion portion 48b, the second expansion portion 49a, the first expansion portion 48c, and the second expansion portion 49b are all present at different positions in the axial direction of the rotary shaft 44, the flow of developer produced as the second spiral 44 rotates is stabilized, and thus the stirring of developer is also stabilized.

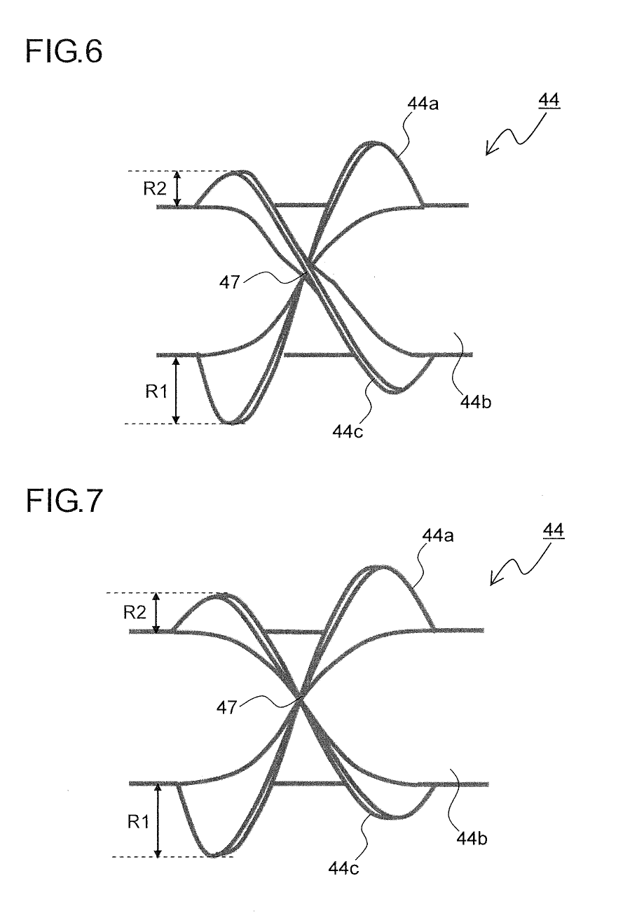

FIG. 6 is a partly enlarged view of the second spiral 44 according to a second embodiment of the present disclosure as seen from the direction perpendicular to the rotary shaft 44b. In the embodiment, the radial height R1 of the first helical blade 44a is the smaller the closer to the intersection 47 such that, at the intersection 47, R1=0. Otherwise, the structure of the first spiral 44 is similar to that in the first embodiment.

With this configuration, the developer stagnating near the intersection 47 is more likely to disperse over the first helical blade 44a. The developer is more likely to enter, over the first helical blade 44a, a region near the intersection 47 where the density of developer is low. Thus, as in the first embodiment, it is possible to prevent developer from being uneven locally near the intersection 47, and thus to effectively overcome image unevenness resulting from non-uniform developer being fed to the developing roller 20. The second helical blade 44c is formed continuously without being interrupted at the intersection 47, and thus the conveying force in the opposite direction of the second helical blade 44c is prevented from reducing; this eliminates the danger of a reduced stirring effect on developer.

FIG. 7 is a partly enlarged view of the second spiral 44 according to a third embodiment of the present disclosure as seen from the direction perpendicular to the rotary shaft 44b. In this embodiment, the radial height R1 of the first helical blade 44a and the radial height R2 of the second helical blade 44c are the smaller the closer to the intersection 47 such that, at the intersection 47, R1=0 and R2=0. Otherwise, the structure of the second spiral 44 is similar to that in the first embodiment.

With this configuration, as in the first and second embodiments, the developer stagnating near the intersection 47 is more likely to disperse over the first helical blade 44a and the second helical blade 44c. The developer is more likely to enter, over the first helical blade 44a and the second helical blade 44c, a region near the intersection 47 where the density of developer is low. Thus, it is possible to prevent developer from being uneven locally at the intersection 47, and thus to effectively overcome image unevenness resulting from non-uniform developer being fed to developing roller 20.

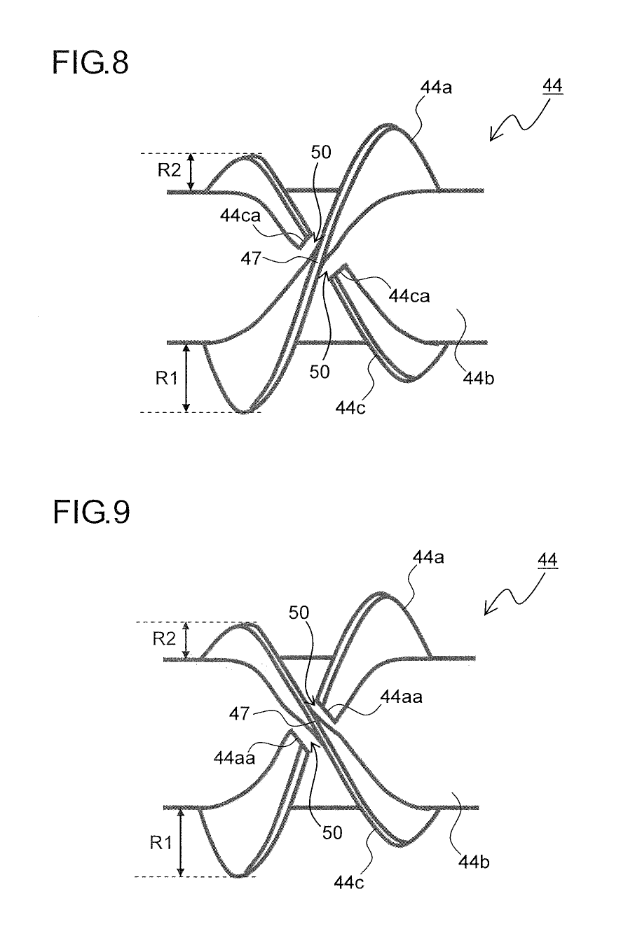

FIG. 8 is a partly enlarged view of the second spiral 44 according to a fourth embodiment of the present disclosure as seen from the direction perpendicular to the rotary shaft 44b. In this embodiment, the radial height R2 of the second helical blade 44c is constant except at the intersection 47 such that, only near the intersection 47, R2=0. That is, edges 44ca of the second helical blade 44c are arranged opposite each other across gaps 50 on opposite side surfaces of the first helical blade 44a passing through the intersection 47. Otherwise, the structure of the second spiral 44 is similar to that in the first embodiment.

With this configuration, the developer stagnating near the intersection 47 is more likely to disperse through the gaps 50. The developer is more likely to enter, through the gaps 50, a region near the intersection 47 where the density of developer is low. Thus, it is possible to suppress stagnation of developer and lowering of developer density near the intersection 47, and thereby to prevent developer from being uneven locally near the intersection 47; it is thus possible to effectively overcome image unevenness resulting from non-uniform developer being fed to the developing roller 20. The first helical blade 44a is formed continuously without being interrupted at the intersection 47, and thus there is no danger of a reduced conveying force of the first helical blade 44a.

FIG. 9 is a partly enlarged view of the second spiral 44 according to a fifth embodiment of the present disclosure as seen from the direction perpendicular to the rotary shaft 44b. In this embodiment, the radial height R1 of the first helical blade 44a is constant except at the intersection 47 such that, only near the intersection 47, R1=0. That is, edges 44aa of the first helical blade 44a are arranged opposite each other across gaps 50 on opposite side surfaces of the second helical blade 44c passing through the intersection 47. Otherwise, the structure of the second spiral 44 is similar to that in the first embodiment.

With this configuration, as in the fourth embodiment, the developer stagnating near the intersection 47 is more likely to disperse through the gaps 50. The developer is more likely to enter, through the gaps 50, a region near the intersection 47 where the density of developer is low. Thus, it is possible to prevent developer from being uneven locally near the intersection 47, and thus to effectively overcome image unevenness resulting from non-uniform developer being fed to the developing roller 20. The second helical blade 44c is formed continuously without being interrupted at the intersection 47, and thus the conveying force in the opposite direction of the second helical blade 44c is prevented from reducing; this eliminates the danger of a reduced stirring effect on developer.

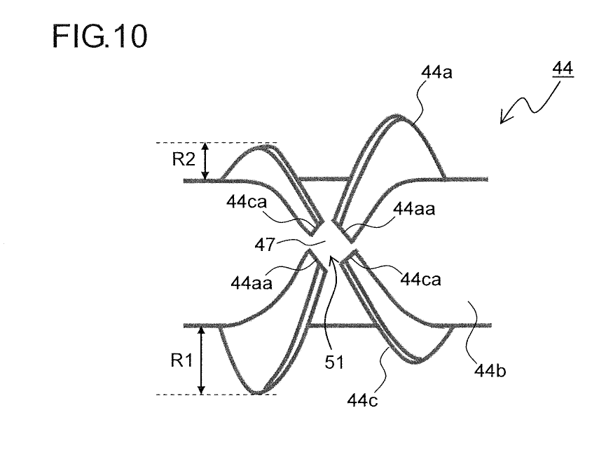

FIG. 10 is a partly enlarged view of the second spiral 44 according to a sixth embodiment of the present disclosure as seen from the direction perpendicular to the rotary shaft 44b. In this embodiment, the radial height R1 of the first helical blade 44a and the radial height R2 of the second helical blade 44c are constant except at the intersection 47 such that, only near the intersection 47, R1=0 and R2=0. That is, across the intersection 47, edges 44aa of the first helical blade 44a and edges 44ca of the second helical blade 44c are both arranged opposite each other across a flat portion 51 in a rectangular shape. Otherwise, the structure of the second spiral 44 is similar to that in the first embodiment.

With this configuration, the developer stagnating near the intersection 47 is more likely to disperse through the flat portion 51. The developer is more likely to enter, through the flat portion 51, a region near the intersection 47 where the density of developer is low. Thus, it is possible to prevent developer from being uneven locally near the intersection 47, and thus to effectively overcome image unevenness resulting from non-uniform developer being fed to the developing roller 20.

In the third and sixth embodiments, at the intersection 47, the radial height R1 of the first helical blade 44a and the radial height R2 of the second helical blade 44c both equal zero, and this permits smoother flow of developer near the intersection 47 as compared in the first, second, fourth, and fifth embodiments. Thus, it is possible to suppress stagnation of developer and lowering of developer density more effectively. On the other hand, since the first helical blade 44a is not located at the intersection 47, the conveying force of developer is weaker than in the first and fourth embodiments. Since the second helical blade 44c is not located at the intersection 47, the stirring effect on developer is weaker than in the second and fifth embodiments.

Based on what is described above, it is preferable to select and use the configurations according to the first to sixth embodiments as necessary according to what is required in the developing device 2a in terms of the conveying force of developer, the stirring effect, and the suppression of stagnation of developer and lowering of developer density.

The embodiments described above are in no way meant to limit the present disclosure, which thus allows for many modifications and variations within the spirit of the present disclosure. For example, as shown in FIG. 3, although the above description deals with the developing device 2a in which the configurations of the first helical blade 44a and the second helical blade 44c as described in the above-described first to sixth embodiments are adopted in the first spiral 43 arranged in the first conveyance chamber 22c and the second spiral 44 arranged in the second conveyance chamber 22d in the developing device 2, depending on the specifications of developer, the stirring/conveying member according to the present disclosure may be used only in the first spiral 43 arranged in the first conveyance chamber 22c to increase the stirring effect only in the first conveyance chamber 22c. Or, the stirring/conveying member according to the present disclosure may be used only in the second spiral 44 arranged in the second conveyance chamber 22d to increase the stirring effect only in the second conveyance chamber 22d. The second spiral 44 has the function of feeding developer to the magnetic roller 21, and thus, to feed developer in a uniform state to the magnetic roller 21 to suppress image unevenness, the configuration according to the present disclosure is preferably applied at least to the second spiral 44.

Although FIG. 5 shows a configuration, as a modified example of the first embodiment, in which the first expansion portions 48a to 48d and the second expansion portions 49a and 49b are formed in the first helical blade 44a and the second helical blade 44c respectively, it is possible, also in the second to sixth embodiments, to form the first expansion portions 48a to 48d and the second expansion portions 49a and 49b in the first helical blade 44a and the second helical blade 44c respectively.

A stirring/conveying member according to the present disclosure is applicable, not only to a developing device 2, like the one shown in FIGS. 2 and 3, which has a developer supply port 22g and a developer discharge port 22h and which includes a magnetic roller 21 and a developing roller 20, but also to various developing devices that use two-component developer containing toner and carrier. Next, by way of practical examples, the effects of the present disclosure will be described more specifically.

### PRACTICAL EXAMPLES

With an image forming apparatus 1 as shown in FIG. 1 incorporating the developing devices 2a to 2d shown in FIGS. 2 and 3, experiments were conducted to study the charging performance of carrier as the configurations of the first spiral 43 in the first conveyance chamber 22c and the second spiral 44 in the second conveyance chamber 22d were varied. The experiment was performed with respect to the image forming portion for magenta which included the photosensitive drum 11a and the developing device 2a.

In the experiment, the first spiral 43 and the second spiral 44 had rotary shafts 43b and 44b with a diameter of 6 mm, first helical blades 43a and 44a with a diameter of 17 mm (a radial height R1 of 5.5 mm) and a blade pitch of 30 mm, and second helical blades 43c and 44c with a diameter of 10 mm (a radial height R2 of 2.0 mm) and a blade pitch of 30 mm. The first spiral 43 and the second spiral 44 of the first embodiment where, as shown in FIG. 4, the radial height R2 of the second helical blade 43c and 44c was the smaller the closer to the intersection 47 such that, at the intersection 47, R2=0 were used in Practical Example 1.

The first spiral 43 and the second spiral 44 of the second embodiment where, as shown in FIG. 6, the radial height R1 of the first helical blades 43a and 44a was the smaller the closer to the intersection 47 such that, at the intersection 47, R1=0 were used in Practical Example 2. The first spiral 43 and the second spiral 44 of the third embodiment where, as shown in FIG. 7, the radial height R1 of the first helical blades 43a and 44a and the radial height R2 of the second helical blades 43c and 44c were the smaller the closer to the intersection 47 such that, at the intersection 47, R1=0 and R2=0 were used in Practical Example 3. The first spiral 43 and the second spiral 44 where neither the radial height R1 of the first helical blades 43a and 44a nor the radial height R2 of the second helical blades 43c and 44c was the smaller the closer to the intersection 47 were used in Comparative Example.

The developing devices 2a of Practical Examples 1 to 3 and Comparative Example were each charged with a predetermined amount of two-component developer containing positively charged toner having an average particle diameter of 6.8 μm and ferrite/resin-coated carrier having an average particle diameter of 35 μm. While the charging amount of developer was varied in steps, five halftone images each were printed with a printing ratio of 25%. By visually comparing image evenness among the printed images and a boundary sample, the printed images were evaluated to be either good when the image evenness was equal to or higher than that of the boundary sample or poor when the image evenness was lower than that of the boundary sample.

The images were formed under the following conditions. The developing roller 20 had a diameter of 20 mm, and was trail-rotated (in the reverse direction) at the plane facing the photosensitive drum 11a at a peripheral speed ratio of 1.8 to the photosensitive drum 11a. The gap between the photosensitive drum 11a and the developer roller 20 was 0.3 mm. The photosensitive drum 11a comprised an a-Si photosensitive member laid with an amorphous silicon photosensitive layer, and was subjected to a white background part potential (light potential) of +270 V and an exposed part potential (dark potential) of +20 V.

To the developing roller 20, a developing bias was applied having superimposed on a DC bias (Vdc) of 190 Van AC bias having rectangular waves with a peak-to-peak value of 1250 V, a frequency of 3.7 kHz, and a duty ratio of 50%. Table 1 shows the results.

TABLE 1

| DEVEL- | FIRST AND SECOND SPIRAL CONFIGURATION | | | |
|---|---|---|---|---|
| OPER | PRACTICAL | PRACTICAL | PRACTICAL | COM- |
| AMOUNT | EXAMPLE | EXAMPLE | EXAMPLE | PARATIVE |
| [g] | 1 | 2 | 3 | EXAMPLE |
| 160 | GOOD | GOOD | POOR | POOR |
| 180 | GOOD | GOOD | GOOD | POOR |
| 200 | GOOD | GOOD | GOOD | POOR |
| 220 | GOOD | GOOD | GOOD | POOR |
| 240 | GOOD | GOOD | GOOD | GOOD |
| 260 | GOOD | GOOD | GOOD | GOOD |
| 280 | GOOD | GOOD | GOOD | GOOD |
| 300 | GOOD | GOOD | GOOD | GOOD |

Table 1 reveals the following. In Practical Example 1, where the radial height of the second helical blades 43c and 44c equaled zero at the intersection 47, and in Practical Example 2, where the radial height of the first helical blades 43a and 44a equaled zero at the intersection 47, the image evenness was good with any amount of developer from 160 g to 300 g. In Practical Example 3, where the radial heights of the first helical blades 43a and 44a and the second helical blades 43c and 44c both equaled zero at the intersection 47, the image evenness was good with an amount of developer from 180 g to 300 g but not with an amount of developer of 160 g.

In contrast, in Comparative Example, where the radial heights of the first helical blades 43a and 44a and the second helical blades 43c and 44c did not vary at the intersection 47 of the first helical blades 43a and 44a and the second helical blades 43c and 44c, the image evenness was good with an amount of developer from 240 g to 300 g but poor with an amount of developer from 160 g to 220 g. The image evenness was the better the larger the amount of developer in the developing device 2a because the ratio of conveyed toner to stagnant toner was then higher.

Based on the above results, it has been confirmed that, with the configurations of Practical Examples 1 to 3, the image evenness is good irrespective of the amount of developer as compared with the configuration of Comparative Example. The reason is considered to be as follows. In Practical Examples 1 to 3 where at least one of the radial height of the first helical blades 43a and 44a and the radial height of the second helical blade 43c and 44c equaled zero at the intersection 47, stagnation of developer and lowering of developer density near the intersection 47 were suppressed as compared with the configuration of Comparative Example where neither the radial height of the first helical blades 43a and 44a nor the second helical blades 43c and 44c equaled zero at the intersection 47. The reason that the image evenness was low with an amount of developer of 160 g in Practical Example 3 is considered that, with the configuration of Practical Example 3, the effect of conveying developer was weak with no helical blade located at the intersection 47 as compared with the configurations of Practical Examples 1 and 2.

Although no specific description will be given, it has been confirmed that a similar result can be obtained with the configurations of the first spiral 43 and the second spiral 44 used in the fourth to sixth embodiments shown in FIGS. 8 to 10.

The present disclosure finds application in developing devices incorporated in image forming apparatuses exploiting electrophotography, such as copiers, printers, facsimile machines, and multifunctional peripherals thereof, and in image forming apparatuses incorporating such developing devices. In particular, the present disclosure finds application as a stirring/conveying member in developing devices that use two-component developer containing toner and carrier.

What is claimed is:

1. A stirring/conveying member comprising:
a rotary shaft rotatably supported in a powder container;
a first helical blade formed on a circumferential surface of the rotary shaft, the first helical blade conveying powder in an axial direction by rotation of the rotary shaft; and
a second helical blade formed on the circumferential surface of the rotary shaft to overlap a forming region of the first helical blade, the second helical blade spiraling in an opposite phase to the first helical blade, the second helical blade having a radial height smaller than a radial height of the first helical blade, wherein
the first helical blade and the second helical blade have a trapezoidal sectional shape on a plane traversing the helical blades in a longitudinal direction thereof,
the first helical blade crosses the second helical blade at least at one place in one turn about the rotary shaft, and
at least one of the radial heights of the first helical blade and the second helical blade equals zero at an intersection of the first helical blade and the second helical blade.

2. The stirring/conveying member of claim 1, wherein
at least one of the radial heights of the first helical blade and the second helical blade is the smaller the closer to the intersection and equals zero at the intersection.

3. The stirring/conveying member of claim 2, wherein
both the radial heights of the first helical blade and the second helical blade are the smaller the closer to the intersection and equal zero at the intersection.

4. The stirring/conveying member of claim 1, wherein
at least one of the radial heights of the first helical blade and the second helical blade is constant except at the intersection and equals zero near the intersection.

5. The stirring/conveying member of claim 4, wherein
both the radial heights of the first helical blade and the second helical blade are constant except at the intersection and equal zero near the intersection.

6. The stirring/conveying member of claim 1, wherein
the first helical blade and the second helical blade cross each other at two places at an interval of 180° from each other in one turn about the rotary shaft.

7. The stirring/conveying member of claim 1, wherein
let the radial height of the first helical blade be R1 and let the radial height of the second helical blade be R2, then ¼×R1≤R2≤½×R1 holds.

8. The stirring/conveying member of claim 1, wherein
in the first helical blade, a plurality of first expansion portions are formed where a base part of a trapezoid of the first helical blade expands wider than elsewhere in one turn about the rotary shaft,
in the second helical blade, a plurality of second expansion portions are formed where a base part of a trapezoid of the second helical blade expands wider than elsewhere in one turn about the rotary shaft, and
the first helical blade crosses the second helical blade at least at one place at the first expansion portion in one turn about the rotary shaft.

9. A developing device comprising:
a developer container which stores two-component developer containing carrier and toner;
a developer carrying member arranged in the developer container, the developer carrying member carrying developer in the developer container; and
the stirring/conveying member of claim 1 which conveys, while stirring, developer in the developer container.

10. The developing device of claim 9, wherein
the developer container has:
a plurality of conveyance chambers, including a first conveyance chamber and a second conveyance chamber, arranged side by side;
communication portions through which the conveyance chambers communicate with each other in opposite end parts of the first and second conveyance chambers in a longitudinal direction thereof; and
a toner supply port through which toner is supplied into the first conveyance chamber,
the developer carrying member is arranged to carry on a surface thereof developer in the second conveyance chamber,
and the developing device further comprises:
a first stirring/conveying member which conveys, while stirring, developer in the first conveyance chamber in an axial direction of a rotary shaft; and
a second stirring/conveying member which conveys, while stirring, developer in the second conveyance chamber in an opposite direction to the first stirring/conveying member, and
the stirring/conveying member of claim 1 is used as the second stirring/conveying member.

11. The developing device of claim 10, wherein
the stirring/conveying member of claim 1 is used as the first stirring/conveying member.

12. An image forming apparatus comprising the developing device of claim 9.
